(19) United States
(12) Patent Application Publication
(10) Pub. No.: US 2004/0117283 A1
(43) Pub. Date: Jun. 17, 2004

(54) Methods and systems for rating financial reporting of public companies and rating the performance of accounting firms

(76) Inventor: Victor F.. Germack, New York, NY (US)

Correspondence Address: GLEN E. BOOKS, ESQ., LOWENSTEIN SANDLER PC, 65 LIVINGSTON AVENUE, ROSELAND, NJ, 07068, US

(21) Appl. No.: 10/621,916

(22) Filed: Jul. 17, 2003

Related U.S. Application Data
(60) Provisional application No. 60/396,895, filed on Jul. 17, 2002.

(51) Int. Cl. G06F 17/60

(52) U.S. Cl. 705/35; 705/36

(57) ABSTRACT

The invention provides methods and systems for rating corporate financial reporting and systems and methods for rating accounting firms. According to one embodiment, public filing information for a company is obtained and separated into predetermined rating categories. The company is then rated in each of the rating categories as well as on an overall basis. According to another embodiment, an average financial performance rating of companies audited by an accounting firm is determined, financial information regarding the accounting firm is obtained, and the accounting firm is then rated.

### CROSS REFERENCE TO RELATED APPLICATIONS

This application claims the benefit of U.S. Provisional Application Serial No. 60/396,895, filed on Jul. 17, 2002, incorporated by reference herein in its entirety.

### BACKGROUND OF THE INVENTION APPLICATION

1. Field of the Invention

The invention is directed to methods and systems for evaluating and rating the financial reporting practices of public companies and the performance of major accounting firms.

2. Background of the Invention

There has been a continuing series of problems concerning corporate disclosures and accounting practices. Overly aggressive accounting practices have inflated corporate income statements and balance sheets. As a result, investor confidence has been negatively impacted, which, in turn, has significantly affected the financial markets, hundreds of billions of dollars of market value has been erased, and the credibility of the accounting profession has been seriously eroded.

Organizations formed to regulate and provide accounting-practice information have not been able to fully address the problem. According to a recent report from the General Accounting Office, the Security and Exchange Commission's (“SEC”) workload increased by 80% in the 1990s, but its staffing rose only 20%. In 2001, for example, the SEC reviewed only 16% of all annual reports. Even the credit agencies such as Standard and Poor's Corporation (“S&P”) and Moody's have come under criticism for their delayed ratings downgrades, particularly in the cases of Enron and Global Crossing.

Information and statistics relating to companies' revenue is very important to investors. Unfortunately, however, there is no uniform standard relating to revenue reporting and no single standard for revenue recognition. GAAP is considered the “Gold Standard” in presenting a corporation's financial results. GAAP is a rules-based system. Its opponents, however, say it is too detailed and technical and is open to manipulation. The nation's accounting rule-making body, the Financial Accounting Standards Board (“FASB”) is seeking to broaden the existing rules regarding revenue recognition and to clarify many other rules. But the FASB itself has come under intense criticism for caving in to pressure from corporations and accounting firms, when they sought to tighten their standards particularly as they relate to special purpose entities. Compounding investors' concerns and causing additional investor confusion is the widespread use of pro form a accounting methods rather than using GAAP methods for earnings' comparisons.

Treatment of stock options is another problem area. U.S. companies often expense the cost of stock options for tax purposes, which is quite aggressive, and which is not reflected on their GAAP profit and loss statements. Almost all U.S. companies exclude the cost of stock options in calculating net income. The conservative approach is to include the expense of stock options in calculating net income. There have been repeated calls for changing the accounting treatment for stock options.

S&P has recently adopted a new formula, which uses a conservative approach, in calculating earnings. S&P found each of the alternative definitions of earnings to be deficient— whether it is reported earnings, operating earnings, or pro form a earnings. Many consider the pro form a earnings approach to have been misused and abused. S&P came up with the concept of “core earnings”, which S&P defines as, “after-tax earnings generated from a corporation's primary business or businesses”. Using the old definition of earnings, the S&P shows a P/E multiple of 22 times. Under S&P's “core-earnings” approach, the P/E multiple increases to 30 times earnings, as of May 20, 2002. These changes speak to the need for clearer, transparent, more consistent and conservative financial reporting.

Recent major bankruptcies and numerous settlements have eroded the credibility of major accounting firms. The main issue is the independence of the auditor and the quality of the work that is performed. Many accounting firms provide both auditing and consulting services to their clients, which presents an enormous conflict. It goes to the issue of accounting firm independence. It is particularly troubling when accounting firms profit more from non-audit fees than from audit fees.

In summary, numerous accounting problems and widespread investor concerns have brought to light the pressing need for methods and systems for evaluating, rating, and ranking the financial reporting of public corporations and of evaluating, rating, and ranking the completeness, accuracy, and integrity of the auditing work performed by accounting firms that audit public corporations.

### 3. SUMMARY OF THE INVENTION

The invention provides methods and systems for evaluating and rating corporate financial reporting and methods and systems for evaluating and rating accounting firms that will offer substantial benefits to investors and help to restore their confidence.

According to one embodiment, public filing information for a company is obtained and separated into predetermined rating categories. The company is then rated in each of the rating categories as well as on an overall basis. According to another embodiment, a company is rated using a plurality of financial factors which are correlated and related to quality of earnings and accounting grading. A weight for each of a list of the factors is determined. At least some of the factors are weighted differently (e.g., high-weight factors, moderate-weight factors, and low-weight factors). According to another embodiment, an average financial performance rating of companies audited by an accounting firm is determined, financial information regarding the accounting firm is obtained, and the accounting firm is then rated.

Various aspects of the present invention utilize a rules-based computerized system. The rules-based computerized system is provided with financial information derived from U.S. Securities and Exchange Commission data. The financial information used by the invention can be obtained by various financial information providers such as, for example, MULTEX, COMPUSTAT, and MEDIA GENERAL, and stored as structured information in a database. Alternatively, the financial reporting information can be directly obtained from the financial reports or by using the EDGAR Online database, which provides access to such reports via the Internet.

### 4. BRIEF DESCRIPTION OF THE DRAWINGS

Various exemplary embodiments of this invention are described in detail with reference to the following figures, where like numerals reference like elements, and wherein:

FIG. 1 is a block diagram showing rating categories used to rate financial reporting of a company;

FIG. 2. is a flow diagram outlining an exemplary technique for rating a company;

FIG. 3 illustrates an exemplary report with rating information; and

FIG. 4 is a block diagram showing rating categories used to rate the performance of accounting firms.

### 5. DETAILED DESCRIPTION OF THE INVENTION

A preferred implementation of the present invention utilizes the Application Service Provider (ASP) or Web server model. As is understood by those of skill in the art, an ASP is an entity that offers individuals and enterprises access to the Internet (or other communications network) to applications and related services that would otherwise have to be located in local computers and/or devices.

Exemplary data processing systems which may be utilized in accordance with embodiments of the present invention include, but are not limited to, Sun MicrosystemsE, Apple®, IBM®, or IBM®-compatible personal computers and workstations. However, it is to be understood that various computing devices and processors may be utilized to carry out embodiments of the present invention without being limited to those enumerated herein. An exemplary operating system may include LINX®, UNIX, Windows 98®, Windows 2000®, or Windows NT®.

The Web server for use in the invention is configured to handle communications with client devices and other devices that are in communication with the communications network. Web servers are well understood by those of skill in the art.

5.1 Rating the Reporting of Financially Relevant Information of a Plurality of Companies

In one embodiment, the invention provides methods and systems for evaluating and rating companies in a corporate target market for the quality, content, and completeness of the reporting of financially relevant information and outlining areas of concern or potential financial exposure that the companies' reporting might reveal. The methods and systems of the invention use key Securities and Exchange Commission reporting requirements −10Ks, 10Qs, 8Ks, proxies, etc. and key company financial press announcements. Preferably, rating reports for each company are prepared on a periodic basis (e.g., a quarterly and/or annual report).

The phrase “corporate target market” or “selected companies”, as used herein, means a particular set of companies selected for evaluating using the methods and systems of the invention. Preferably, the corporate target market comprises the S&P 500.

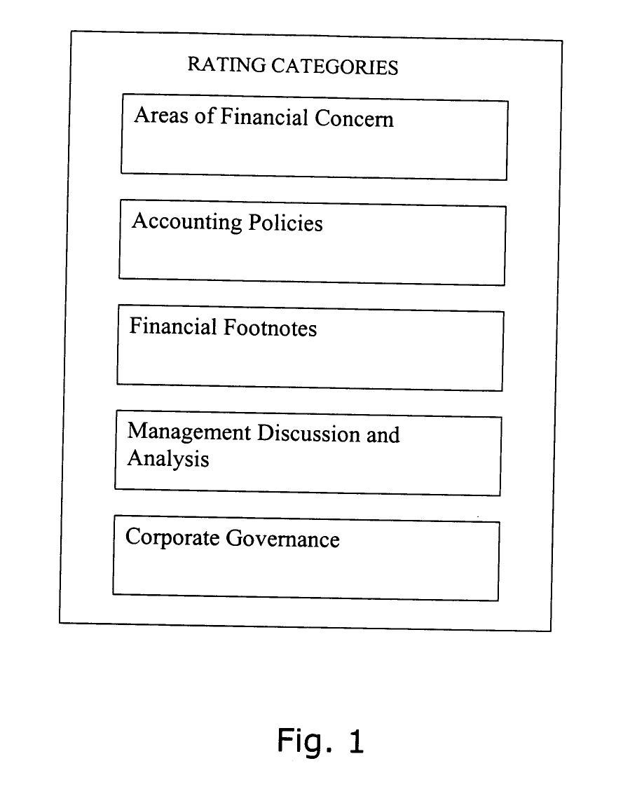

According to an embodiment of the invention, each company in the corporate target market is evaluated and rated according to each of the five rating categories shown in FIG. 1, namely:

(a) Areas of financial concern or potential financial exposures

(b) Accounting policies and practices;

(c) Financial footnotes;

(c) Management's discussion and analysis;

(d) Corporate governance.

Preferably, the selected companies are compared to each other and against all companies in their peer industry group. As a result, each company that is rated receives an individual rating in each of the five rating categories and an overall single summary rating, preferably, expressed as a star rating and also as a number.

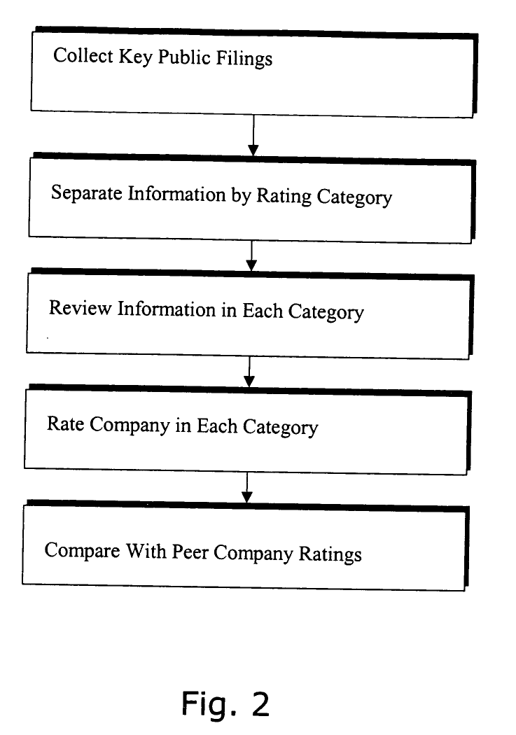

Referring to FIG. 2, according to one embodiment of the invention, the following steps are performed: Collecting the key public filings (such as the 8Ks, 10Ks, 10Qs, Annual Reports, Proxies, etc.) for each company in the corporate target market (step 201); separating information contained in the filings according to the rating category for which it is relevant (step 202); reviewing and summarizing the material and information corresponding to each of the five rating categories (step 203); rating the company in each of the five rating categories and determining a general or summary rating for each company and entering the ratings into a computer for computation and analysis and for comparison with prior-period and yearly results (step 204); totaling, averaging, and analyzing the rating results for each industry group (step 205). Preferably, each company's ratings are compared against its peer group's results, on an average and quartile-ranking basis.

Preferably, in each of the five rating categories, the highest rating is five stars or the number 5 and the lowest rating is one star or the number 1. Each rating category is accorded about equal weight, except that the “areas of financial concern or potential financial exposure” is weighted higher, for example, from about 50% to about equal to the total of the other four rating categories. Thus, according to this weighting and point system, the highest number available to an individual company in the corporate target market is 40 (i.e., 5 points each for the first four criteria, giving a total of 20 plus 20 for the rating category of “areas of concern or potential financial exposure”).

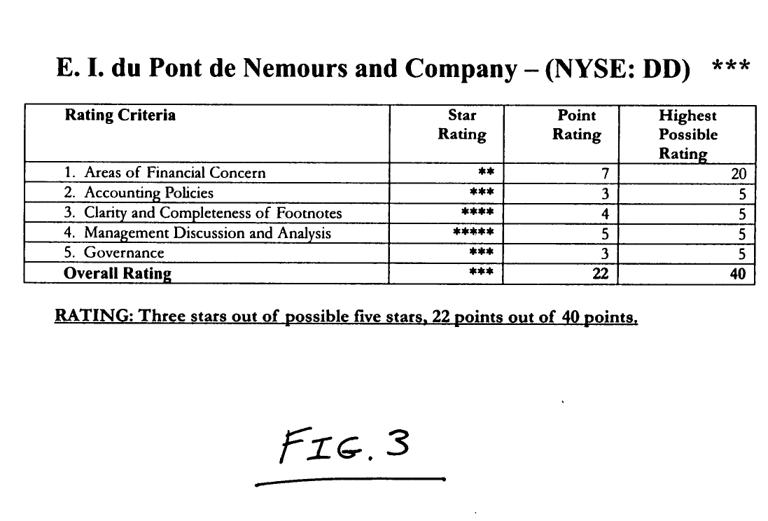

FIG. 3 illustrates an exemplary report containing rating information for a particular company. As depicted in FIG. 3, the company rated is E.I. du Pont de Nemours and Company. The company received an overall rating of 22 points out of a possible 40 points, and an overall three stars. The company also received ratings in each of five categories.

5.1.1 Areas of Financial Concern or Potential Financial Exposure

According to the invention, the rating category of “Areas of Financial Concern or Potential Financial Exposure” is evaluated and rated. Preferably, a written description of the major findings is provided. This measure includes actual or potential problems or exposures impacting revenues, earnings, margins, write-offs, etc. The quality of earnings of the company is closely examined. According to this aspect of the invention, the areas that are evaluated in reaching a rating may include, but are not limited to, one or more of the following:

(a) Whether cash generated by the company tracks earnings.

(b) Whether there are revenue-recognition issues, for example, does the company follow other companies' practices in its peer industry group and whether its accounting for revenue practices are conservative or aggressive.

(c) Whether there is impairment of goodwill or other intangible assets.

(d) The company's track record with respect to discontinued operations write-offs.

(e) The nature and extent of off-balance sheet arrangements and Special Purpose Entities. For example, whether the Special Purpose Entity has a legitimate business purpose and whether the company implicitly guarantees their Special Purpose Entities. Does the company have a track record of aiding their Special Purpose Entity, particularly, when failure to do so might hurt their credit standing in the capital markets? Furthermore, are the associated risks reflected on the company's balance sheet?

(f) The nature and extent of related-party transactions, such as the business purpose and whether there is full financial disclosure. If conflicts of interest exist in such related party transactions, are they identified? Is the potential financial exposure quantified? Is off-balance sheet debt or parent guarantees fully disclosed?

(g) Has or will the company violate its debt covenants or been hit with tougher credit restrictions by their lenders?

(h) Does the company's management disclose how it makes accounting policy decisions?

(i) Does the company make changes in its accounting policies without adequate disclosure or rationale?

(j) Does the company discuss the risks associated with their financing or trading partners, known as counter-parties?

(k) Is there a full disclosure about the financial risks from asbestos or other products-liability issues?

(l) How does the company's management determine the fair market value of non-exchange-traded financial and commodity contracts? And is this consistent with other companies in its peer group?

(m) What is the use and extent of hedging transactions and derivative financial instruments? Is their financial exposure quantified?

(n) Does the company discuss its risk-management philosophy and how it specifically deals with its major risks and exposures?

(o) Has the company's auditor given a qualified opinion or noted some deficiencies? Have the rating agencies changed their rating of the company?

(p) What is the extent of insider stock sales? How does the salary and incentive package of the company's senior management compare to its industry peer group?

(q) Are benefit and pension plans over or under funded, and how does such funding impact earnings?

(r) Are the company's liquidity and capital resources adequate to finance its growth, capital expenditures, acquisitions, and service its debt?

5.1.2 Accounting Policies and Practices

Variables associated with accounting policies and practices include, but are not limited to, whether revenue has been inflated and whether there has been disclosure of loans, losses, and insider dealing or trading. Rating companies' accounting practices will focus on the degree of financial disclosure and where the companies' accounting methods fall in the spectrum of aggressive to conservative. Companies with more conservative policies and more financial disclosure are awarded more points. For example, only one star might be awarded to companies with very speculative or aggressive accounting policies but up to five stars for companies with very conservative accounting policies. Similarly, companies with full financial disclosure will receive a higher rating whereas companies having accounting practices and reports that are hard to penetrate and difficult to understand due to their complexity will receive a lower rating.

One of skill in the art can readily select factors, variables, and data that could be compiled, weighted, and evaluated to determine the conservative or aggressive nature of a company's accounting methods. This will, to some extent, depend on the nature of the business. For example, a company's P&L statements could be reviewed to determine whether they clearly and completely disclose research and development expenses; limiting restructuring charges from ongoing operations, instead of using them as a catch-all for a variety of purposes; write-downs of depreciable or amortizable operating assets; pension costs and employee stock-option-grant expenses. In this example, companies that include such information will receive a higher rating. On the other hand, companies that include in their P&L statements such items as: goodwill write-offs; gains and losses from asset sales; pension gains; unrealized gains and losses from hedging activities; merger and acquisition expenses; and litigation or insurance windfalls will receive fewer points. One of skill in the art can readily adapt or develop software applications to compile and evaluate such data.

Examples of specific aggressive and fraudulent accounting practices are listed below:

(a) Revenue recognition issues and inflating revenue— so called “swap or wash trades”, “round-trip” transactions, “stuffing the channels”, barter deals and vendor-financing arrangements that may have boosted revenue but lacked economic substance;

(b) Self-dealing and insider trading on the part of senior corporate officers/major stockholders and the use of corporate funds for personal loans and for personal gain;

(c) Lack of disclosure of related-party transactions and conflicts of interest; and

(d) Adoption of aggressive accounting policies— impacting revenue and earnings which involved double-counting or inflating revenue, reserves, inventories, inventory “stuffing”, stock options, pension plans, tax deferrals, investment gains.

5.1.3 Financial Footnotes

According to the invention, the financial footnotes of companies' public reports are reviewed for clarity, accuracy, and completeness. If the footnotes are very clear, well written, and complete and they accurately cover all a company's relevant issues, then the company receives a favorable rating (e.g., a four or five star rating). On the other hand, if the footnotes are confusing, misleading and/or don't include information reasonably expected based on a comparison with peer or industry group companies, then a company would receive a lower rating (e.g., a one or two star rating).

5.1.4 Management's Description of Operating And Financial Results

According to the invention, management's description of operating and financial results is rated. This involves evaluation of the completeness and transparency of management's commentary and reporting contained in the various financial reports, including the president's/chairman's letter to shareholders. For example, if a company's management describes, in detail, its major operations; existing and new products; operating results; deviations from plan; major problems; potential risks in significant detail; any required regulatory approvals; litigation; and management's future plans and strategy, then that company receives a strong rating. If, on the other hand, management omitted or minimized discussion of serious or potential problems or conditions impacting earnings, revenues, reserves, margins, default rates, costs, management, or important issues commented on by other companies in its peer group, etc. then that company would receive a lower rating.

5.1.5 Corporate Governance

According to the invention, each company is rated by comparing its corporate governance policies and structure to the commonly accepted ‘best practices’ of corporate governance. Areas of corporate governance that are evaluated include, but are not limited to, the composition of the company's board of directors (e.g., the number of independent directors versus inside directors; ideally, public companies should have a majority of directors independent from senior management); the qualifications of directors; the method of selecting and election of outside directors (ideally, outside directors are elected by a nominating committee of non-management directors); the company's definition of the term “independent director”; whether the company requires independent directors or the firms they control to receive no income from providing services or products to the company; the composition and duties of the company's audit and compensation committees (ideally these committees are composed of all independent directors); whether all related-party transactions have been approved by the audit and compensation committees; whether the independent directors have regular access to independent legal counsel and whatever other expert advice that they need to effectively perform their duties; and whether shareholders approve all option grants to corporate officers and employees alike. It should be appreciated, however, that as legislation affecting corporate governance is changed and new legislation is enacted (e.g., Sarbanes-Oxley Act) the manner in which the invention rates a company's corporate governance policy can be adjusted to reflect the new state of affairs.

Examples of specific governance problems are listed below:

(a) Senior corporate officers who have received outrageous compensation while their companies' stocks have declined significantly;

(b) Inability of directors to detect and/or evaluate any related-party transaction to insure the companies are avoiding conflicts of interest; and

(c) Inability of audit-committee members to be truly independent and to be effective in insuring adequate disclosure and compliance.

In an alternate embodiment of the invention, various financial factors having a correlation and relationship to quality of earnings and accounting grading are used to determine a rating score that is used to rank the quality of a company's financial statements. Preferably, the financial factors chosen and the determination of the rating score will be consistent over time but permit flexibility to adapt when it is appropriate to do so. As a practical application, thirty-two financial factors have been studied for correlation and relationship to quality of earnings and accounting grading, and fifteen of these have been identified as being useable, supported by statistical methods and incorporated into an active ranking process based on the strength of the correlation. Each factor has an assigned influence weight:

High Weight Factors: The factors with the greatest correlation and statistical significance, generally having a weight twice that of moderate weight factors.

Moderate Weight: The factors that are correlated but which do not fall into the high weight category.

Low Weight: The factors that are relevant but whose statistical significance is not sufficiently strong, generally having a weight half that of the moderate weight factors.

Of the fifteen factors, two are high weight, four are moderate weight, and nine are low weight. The financial factors are listed below.

1. (High) The charge for discontinued operations is positive. The charge for discontinued operations may be deferred to delay the timing of recognition. In this case, discontinued operations may be overstated in order to improve future earnings.

2. (High) The current quarter ratio of gross profit to net sales has increased over the average ratio for the prior four quarters by more than five percent. This may indicate problems in revenue recognition and/or expenses. This is an indication that there may be problems in the quality of revenue.

3. (Moderate) The charge for extraordinary items is positive. Extraordinary items may be deferred to delay the timing of recognition. Extraordinary items may then be overstated in order to improve future earnings.

4. (Moderate) Any of the following is present: impairment-assets held for use; amortization of intangibles; and net goodwill changed from the previous quarter by more than five percent. The timing and degree of these flows are left to the judgment of the company.

5. (Moderate) A restructuring charge is present. Second and subsequent occurrences each count as 1.5 times the weight of the first occurrence. Restructuring charges may be understated to obscure seriousness of business conditions. Restructuring charges may be overstated in order to improve future earnings.

6. (Moderate) A charge for purchase R&D written-off is present. This may be used to shift earnings to different period(s). In practice, this is a contrarian indicator showing conservative practices.

7. (Low) A financial restatement has occurred. All restatements are counted. Restatements that decrease earnings are counted with double the weight of restatements that increase earnings.

8. (Low) Either of the following improves earnings by more than two percent: loss (gain) on sale of assets— operating; gain (loss) on sale of assets. The timing of the sale of assets that improve earnings may be for the purpose of boistering earnings.

9. (Low) A charge for any of the following is present: interest capitalized (operating); interest capitalized (non-operating); interest capitalized (supplemental). Capitalizing interest reduces expenses in the current period.

10. (Low) The ratio of unusual expense (income) to sales is greater than two percent. Unusual expense (income) may be used to shift earnings to a future (from a prior) period.

11. (Low) A charge for accounting change is positive. Non-mandatory accounting changes may be used to defer earnings to a future period.

12. (Low) The difference in the year-over-year change in total inventory exceeds the difference in the year-over-year (4-quarter sum) change in net sales by more than 20% when sales decline or by more than 10% when sales increase. Inventories usually fluctuate relative to sales. Other changes may be the result of business conditions or manipulation of inventory valuation or inventory management.

13. (Low) The charge for accounting change is negative. Non-mandatory accounting changes may be used to increase earnings in the current period.

14. (Low) The charge for discontinued operations is negative. Discontinued operations may be used to increase earnings in the current period.

15. (Low) The charge for extraordinary items is negative. Extraordinary items may be deferred to delay the timing of recognition. Extraordinary items may then be understated in order to improve future earnings.

5.2 Rating the Major Accounting Firms

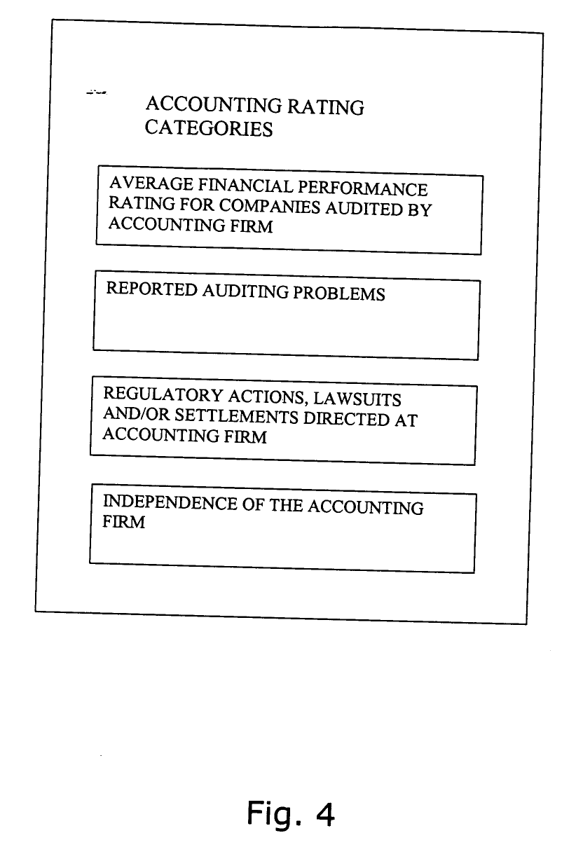

In another embodiment, the invention relates to evaluating and rating completeness, accuracy, and integrity of the auditing work of the major CPA/accounting firms. These ratings will show how well the accounting firms audit the corporate target market and their overall track records. The financial audit rating technology disclosed herein focuses on four major rating categories (as summarized in FIG. 4):

1. An average of the ratings received according to the methods and systems disclosed in Section 5.1 above by the companies in the corporate target market that each accounting firm audits;

2. Reported auditing problems and qualified opinions concerning their clients that should have been expressed earlier, bankruptcies, etc.;

3. Regulatory actions, lawsuits, and/or settlements directed at the accounting firm; and

4. Independence of the accounting firm.

Preferably, the rating is performed annually, and is calculated on a moving five-year average. Preferably, the major accounting firms that audit the companies in the corporate target market are rated. Each of the four rating categories is weighted equally. For example, from one to five stars for each rating category where each star is valued at one point so that the highest possible total for each major accounting firm is 20 stars.

According to one embodiment of the invention, the following steps are performed: (1) All the companies in the corporate target market that the subject accounting firm represents are identified. Each of these companies has an associated rating −as assigned by the systems and methods disclosed in Section 5.1 above for which an average value is calculated using a computer. (2) All of the relevant financial public filings, reported SEC complaints/actions and settlements, and all financial press articles (electronic and print) for all of the corporate target market companies and all information relating to their specific auditors are collected and reviewed. (3) Material and information relevant to rating categories 2, 3, and 4 is separated, reviewed, and summarized. (4) The findings in each rating category are reviewed and analyzed. (5) The accounting firm is rated in each rating category. (6) The specific ratings and the general summary rating for each of the major accounting firms is entered into a computer for computation and analysis and for comparison with prior-period and yearly results. (7) The rating results for each accounting firm, are totaled, averaged, and analyzed. Each accounting firm's ratings are compared with its peer group results, on an average basis. Preferably, each firm's results are averaged on a yearly and on a five year moving average basis.

5.2.1 Average of the Ratings Received by the Companies in the Corporate Target Market that Each Accounting Firm Audits

The ratings in connection with financial disclosure and accounting policies of each company in the corporate target market will reflect the performance and accounting policy and practices of the accounting firm. The lower the corporate target company's rating, the more poorly this reflects on the company's accounting firm.

5.2.2 Financial or Reporting Problems at Client Companies

According to the invention, client-based problems are compiled and evaluated for each accounting firm. Client-based problems include, but are not limited to: auditing problems reported by the client; qualified audit opinions where the problem(s) causing the qualification were material and apparent earlier and not noted; problems of restated earnings at their clients; client lawsuits directed at their auditors; and client bankruptcies.

5.2.3 Regulatory Actions, Lawsuits and/or Settlements

According to the invention, the selected accounting firms are examined to determine whether they are the subject of any regulatory actions, lawsuits, settlements, or pleas. Examples include, but are not limited to, SEC or state investigations; enforcement actions; complaints; individual civil and class action lawsuits and criminal lawsuits; and adverse legal settlements, including damages, injunctions, fines, and criminal-related settlements, pleas, and prison terms.

5.2.4 Independence of Accounting Firms

According to the invention, each of the selected accounting firms' histories with respect to independent action is evaluated. Factors include, but are not limited to, whether the accounting firm performs both auditing and consulting and other services for the same client; whether the accounting firm perfoms the audit and also acts as the company's internal auditor; whether the auditor jointly generates revenues with an audit client; whether there are financial conflicts of interest between the auditor and the client; whether the accounting firm has had too long of a relationship with its corporate client (ideally, the accounting firm should not work for more than five to seven consecutive years for the same client); and whether the accounting firms have a history of having its audit personnel join the client corporation after they leave the accounting firm.

In view of the above discussion and disclosure it can be seen that in one embodiment, the invention is directed to a corporate financial reporting and rating system, comprising a web server storing information respecting a plurality of selected companies, the information concerning one or more of the following rating categories:

(a) accounting policies and practices;

(b) financial footnotes;

(c) management's description of operating and financial results;

(d) areas of concern or potential financial exposures; and

(e) corporate governance,

the web server providing a user with a rating for each company in each rating category. Preferably, the plurality of selected companies comprises the S&P 500.

In another embodiment, the invention relates to a method of rating a plurality of companies comprising:

(a) analyzing each company in rating categories of:

(i) accounting policies and practices;

(ii) financial footnotes,

(iii) management's description of operating and financial results,

(iv) areas of concern or potential financial exposures, and

(v) corporate governance;

(b) assigning a rating for the company in one or more of the rating categories; and

(c) providing a rating report based on the ratings assigned in the one or more rating categories.

Preferably, the rating categories of (a) accounting policies and practices; (b) financial footnotes; (c) management's description of operating and financial results; and (e) corporate governance are weighted about equally and the rating category of (d) areas of concern or potential financial exposure, is weighted higher, more preferably, the rating category of (d) areas of concern or potential financial exposure, is weighted from about 50% to about equal to the total available points.

In a preferred aspect of this embodiment, the method further comprises uploading the rating report to a web server. In a second preferred aspect of this embodiment further comprises downloading the rating report from the web server to a computer.

In another embodiment, the invention relates to an accounting firm reporting and rating system, comprising web server storing information respecting a plurality of selected accounting firms, the information concerning one or more of the following rating categories:

(a) an average of the ratings received by the companies in the corporate target market that each accounting firm audits;

(b) reported auditing problems and qualified opinions concerning their clients that should have been expressed earlier;

(c) regulatory actions, lawsuits, or settlements; and

(d) independence of the accounting firm, the web server providing a user with a rating for each accounting firm in each rating category.

In another embodiment, the invention relates to a method of rating a plurality of accounting firms comprising:

(a) analyzing each accounting firm in rating categories of:

(i) an average of the ratings received by the companies in the corporate target market that each accounting firm audits;

(ii) reported auditing problems and qualified opinions concerning their clients that should have been expressed earlier;

(iii) regulatory actions, lawsuits, or settlements; and

(iv) independence of the accounting firm,

(b) assigning a rating for the accounting firm in each of the four rating categories; and

(c) Preparing a rating report based on the ratings assigned in the one or more rating categories. Preferably, each rating category is weighted equally.

A preferred aspect of this embodiment further comprises uploading the rating report to a web server.

A second preferred aspect of this embodiment further comprises downloading the rating report from the web server to a computer.

Although the present invention has been described in considerable detail with reference to certain preferred embodiments and versions, other versions and embodiments are possible. Therefore, the spirit and scope of the appended claims should not be limited to the description of the versions and embodiments expressly disclosed herein.

What is claimed is:

1. A method for rating financial reporting of public companies, comprising the steps of:
obtaining public filing information for a company;
separating the obtained public filing information into predetermined rating categories; and
rating the company in each of the rating categories, using the separated public filing information.

2. The method of claim 1, wherein the public filing information includes information required by the Securities and Exchange Commission to be publicly filed.

3. The method of claim 1, wherein at least some of the public filing information is provided as structured information stored in a database.

4. The method of claim 1, wherein rating the company includes assigning a score for each of the rating categories.

5. The method of claim 1, wherein rating the company includes assigning an overall score.

6. The method of claim 5, wherein at least one of the rating categories is accorded a greater weight to the overall score than the others.

7. The method of claim 1, wherein rating the company includes assigning one or more star for each of the rating categories.

8. The method of claim 1, wherein rating the company includes assigning an overall rating of one or more star.

9. The method of claim 1, wherein rating the company includes comparing the company to other companies in its peer industry group.

10. The method of claim 1, wherein rating the company includes comparing the company to other companies that were rated.

11. The method of claim 1, wherein the rating categories include one or more of (1) areas of financial concern and/or potential financial exposure; (2) accounting policies and practices; (3) financial footnotes; (4) management description of operating and financial results; and (5) corporate governance.

12. A method for rating quality of earnings and accounting grading for a company, comprising the steps of:
obtaining public filing information for a company;
determining a weight for each of a plurality of factors, using the obtained public filing information;
rating the company based on the determined weights for the factors, wherein at least some of the factors are weighted differently; and
ranking the company in relation to other companies that were rated.

13. The method of claim 12, wherein the weight for each factor is determined to be one of high weight, moderate weight, and low weight.

14. The method of claim 13, wherein the high weight factors are weighted approximately twice that of the moderate weight factors.

15. The method of claim 14, wherein the low weight factors are weighted approximately half that of the moderate weight factors.

16. The method of claim 12, wherein the factors include one or more of: (1) whether a charge for discontinued operations is positive; (2) whether the current quarter ratio of gross profit to net sales has increased over the average ratio for the prior four quarters by more than a predetermined percent; (3) whether a charge for extraordinary items is positive; (4) whether any of the following is present: impairment-assets held for use; amortization of intangibles; and net goodwill changed from the previous quarter by more than a predetermined percent; (5) whether a restructuring charge is present; (6) whether a charge for purchase R&D written-off is present; (7) whether a financial restatement occurred; (8) whether either of the following improves earnings by more than a predetermined percent: loss (gain) on sale of assets—operating; gain (loss) on sale of assets; (9) whether a charge for any of the following is present: interest capitalized (operating); interest capitalized (non-operating); interest capitalized (supplemental); (10) whether the ratio of unusual expense (income) to sales is greater than a predetermined percent; (11) whether a charge for accounting change is positive; (12) whether the difference in the year-over-year change in total inventory exceeds the difference in the year-over-year (4-quarter sum) change in net sales by more than a predetermined percent when sales decline or by more than a predetermined percent when sales increase; (13) whether the charge for accounting change is negative; (14) whether a charge for discontinued operations is negative; and (15) whether a charge for extraordinary items is negative.

17. A method for rating the performance of an accounting firm, comprising the steps of:
calculating an average financial performance rating of companies audited by the accounting firm;
obtaining financial information regarding the accounting firm, including public filing information; and
rating the accounting firm using the calculated average financial performance rating and the obtained financial information.

18. The method of claim 17, wherein rating the accounting firm includes rating the accounting firm in several categories.

19. The method of claim 18, wherein the categories include one or more of average rating for companies audited by the accounting firm, auditing problems, financial footnotes, and regulatory actions and lawsuits.

20. The method of claim 17, wherein rating the accounting firm includes comparing the rating with peer group results.

21. The method of claim 17, wherein the rating is calculated on a moving average basis.
